(19) United States
(12) Patent Application Publication
(10) Pub. No.: US 2023/0003979 A1
(43) Pub. Date: Jan. 5, 2023

(54) METHOD, APPARATUS, AND DEVICE FOR DETERMINING PARAMETERS OF FISHEYE LENS

(71) Applicant: NANJING NANOTECH INSTITUTE CO. LTD., Nanjing (CN)

(72) Inventors: Qiu Wang, Nanjing (CN); Yuan Wang, Nanjing (CN)

(21) Appl. No.: 17/930,746

(22) Filed: Sep. 9, 2022

Related U.S. Application Data
(63) Continuation of application No. PCT/CN2020/078603, filed on Mar. 10, 2020.

(51) Int. Cl. G02B 13/06; G02B 1/00

(52) U.S. Cl. CPC G02B 13/06; G02B 1/002

(57) ABSTRACT

A method, an apparatus, and a device for determining parameters of a fisheye lens are provided. The fisheye lens includes a meta-lens including a first surface and a second surface, and the first and second surfaces are each provided with a plurality of columnar structures. The method includes: obtaining a focal length and a projection mode of a fisheye lens to be designed; determining a light angle offset of each columnar structure based on the focal length and the projection mode; determining a phase distribution of the columnar structure based on the light angle offset of the columnar structure; and determining a size of the columnar structure according to the phase distribution of the columnar structure. The fisheye lens may achieve a relatively large viewing field in a short distance.

### CROSS-REFERENCE TO RELATED APPLICATION

This application is a continuation of International Application No. PCT/CN2020/078603, filed on Mar. 10, 2020, the disclosure of which is hereby incorporated by reference in its entirety.

### TECHNICAL FIELD

The present application relates to the micro-nano optical imaging field and, in particular, to a method, an apparatus, and a device for determining parameters of a fisheye lens.

### BACKGROUD

A fisheye lens is a kind of lens with an ultra-large viewing angle (generally more than 120°), which was initially designed and proposed by simulation of goldfish eyes in bionics. The fisheye lens has a unique projection mode to meet the physical requirements for obtaining an ultra-large viewing angle, which is different from the linear-type projection mode of a standard lens.

The fisheye lens is essentially a set of lenses composed of multiple groups of glass lenses. A phase of light may be changed due to the inconsistence in thickness from an upper part to a lower part of glass lens, allowing the scattered light to re-converge, thereby making the optical path difference of the light emitting from each point uniform. Assembling of multiple groups of glass lenses makes the fisheye lens have a projection mode different from that of a single glass lens, which may eliminate the phase difference well, and then obtain an ultra-large viewing angle, which may even be close to 180°. At present, traditional fisheye lens is usually composed of no less than eight groups of glass lenses, resulting in relatively large size of fisheye lens.

### SUMMARY

The present application provides a method, an apparatus, and a device for determining parameters of a fisheye lens, which reduces a size of the fisheye lens.

In a first aspect of embodiments of the present application, there is provided a method for determining parameters of a fisheye lens, the fisheye lens includes a meta-lens, the meta-lens includes a first surface and a second surface, the first surface and the second surface are each provided with a plurality of columnar structures, and the method includes:

obtaining a focal length and a projection mode of a fisheye lens to be designed;

determining a light angle offset of each columnar structure based on the focal length and the projection mode;

determining a phase distribution of the columnar structure based on the light angle offset of the columnar structure; and

determining a size of the columnar structure based on the phase distribution of the columnar structure.

In a possible embodiment, determining the light angle offset of each columnar structure based on the focal length and the projection mode includes:

determining wave vectors corresponding to the columnar structure based on the focal length, the projection mode and the position of the columnar structure on the meta-lens; and

determining the light angle offset of the columnar structure based on the wave vectors corresponding to the columnar structure.

In a possible embodiment, the first columnar structure is any one of the plurality of columnar structures.

In a possible embodiment, for a first columnar structure in the plurality of columnar structures, the wave vectors corresponding to the first columnar structure include: a first wave vector, a second wave vector, a third wave vector and a fourth wave vector; where,

the first wave vector is a wave vector of the light prior to passing through the first surface from the first columnar structure;

the second wave vector is a wave vector of the light after passing through the first surface from the first columnar structure;

the third wave vector is a wave vector of the light prior to passing through the second surface from the first columnar structure; and

the fourth wave vector is a wave vector of the light after passing through the second surface from the first columnar structure.

In a possible embodiment,

the first wave vector is represented as:

kᵥ₁=k₀ si n θ;

or, the second wave vector is represented as:

kᵥ₂=nk₀ si n θ₂l;

or, the third wave vector is represented as:

kᵤ₁=nk₀ si n θ₁₀;

or, the fourth wave vector is represented as:

kᵤ₂=k₀ si n θ₁,

where, k₀ is a wave vector in vacuum, k₀=2π l λ, n is a refractive index of the meta-lens, θ is an incident angle of a first parallel light and a second parallel light, θ₁₀ is an exit angle of the first parallel light passing through the first surface from the first columnar structure, θ₂ is an exit angle of the second parallel light passing through the first surface from the first columnar structure, and θ₁ is an exit angle of the first parallel light passing through the second surface.

In a possible embodiment, for the first columnar structure in the plurality of columnar structures, determining a light angle offset of the first columnar structure based on the wave vectors corresponding to the first columnar structure includes:

determining the light angle offset of the first columnar structure on the first surface based on the first wave vector and the second wave vector; and

determining the light angle offset of the first columnar structure on the second surface based on the third wave vector and the fourth wave vector.

In a possible embodiment, for the first columnar structure in the plurality of columnar structures, determining a phase distribution of the first columnar structure based on the light angle offset of the first columnar structure includes:

determining a first phase variation of the first columnar structure on the first surface based on the light angle offset of the first columnar structure on the first surface;

determining a second phase variation of the first columnar structure on the second surface based on the light angle offset of the first columnar structure on the second surface; and

determining the phase distribution based on the first phase variation and the second phase variation.

In a possible embodiment, determining the size of each columnar structure based on the phase distribution of the columnar structure includes:

determining a phase value of the columnar structure based on the phase distribution of the columnar structure;

determining the size of each columnar structure based on the phase value of the columnar structure and a preset corresponding relationship, where, the preset corresponding relationship includes a plurality of phase values and a size corresponding to each phase value.

At a second aspect of embodiments of the present application, there is provided an apparatus for determining parameters of a fisheye lens, the fisheye lens includes a meta-lens, the meta-lens includes a first surface and a second surface, the first surface and the second surface are each provided with a plurality of columnar structures, and the apparatus includes:

an obtaining module configured to obtain a focal length and a projection mode of a fisheye lens to be designed;

a first determination module configured to determine a light angle offset of each columnar structure based on the focal length and the projection mode;

a second determination module configured to determine a phase distribution of the columnar structure based on the light angle offset of the columnar structure;

a third determination module configured to determine a size of the columnar structure based on the phase distribution of the columnar structure.

In a possible embodiment, the first determination module is specifically configured to:

determine wave vectors corresponding to each columnar structure based on the focal length, the projection mode and a position of the columnar structure on the meta-lens; and

determine the light angle offset of the columnar structure based on the wave vectors corresponding to the columnar structure.

In a possible embodiment, for the first columnar structure in a plurality of columnar structures, the wave vectors corresponding to the first columnar structure include: a first wave vector, a second wave vector, a third wave vector and a fourth wave vector; where,

the first wave vector is a wave vector of the light prior to passing through the first surface from the first columnar structure;

the second wave vector is a wave vector of the light after passing through the first surface from the first columnar structure;

the third wave vector is a wave vector of the light prior to passing through the second surface from the first columnar structure; and

the fourth wave vector is a wave vector of the light after passing through the second surface from the first columnar structure.

In a possible embodiment,

the first wave vector is represented as:

kᵥ₁=k₀ si n θ;

or, the second wave vector is represented as:

kᵥ₂=nk₀ si n θ₂;

or, the third wave vector is represented as:

kᵤ₁=nk₀ si n θ₁₀;

or, the fourth wave vector is represented as:

kᵤ₂=k₀ si n θ₁,

where, k₀ is a wave vector in vacuum, k₀=2π l λ, n is a refractive index of the meta-lens, θ is an incident angle of a first parallel light and a second parallel light, θ₁₀ is an exit angle of the first parallel light passing through the first surface from the first columnar structure, θ₂ is an exit angle of the second parallel light passing through the first surface from the first columnar structure, and θ₁ is an exit angle of the first parallel light passing through the second surface.

In a possible embodiment, for the first columnar structure in a plurality of columnar structures, the first determination module is specifically configured to:

determine a light angle offset of the first columnar structure on the first surface based on the first wave vector and the second wave vector; and

determine a light angle offset of the first columnar structure on the second surface based on the third wave vector and the fourth wave vector.

In a possible embodiment, for the first columnar structure in a plurality of columnar structures, the second determination module is specifically configured to:

determine a first phase variation of the first columnar structure on the first surface based on the light angle offset of the first columnar structure on the first surface;

determine a second phase variation of the first columnar structure on the second surface based on the light angle offset of the first columnar structure on the second surface; and

determine the phase distribution based on the first phase variation and the second phase variation.

In a possible embodiment, the third determination module is specifically configured to:

determine a phase value of each columnar structure based on the phase distribution of the columnar structure; and

determine the size of the columnar structure based on the phase value of the columnar structure and the preset corresponding relationship, where the preset corresponding relationship includes a plurality of phase values and a size corresponding to each phase value.

At a third aspect of embodiments of the present application, there is provided a terminal device, including: a processor, which is coupled with a memory;

the memory is configured to store a computer program;

the processor is configured to execute the computer program stored in the memory so as to allow the terminal device to execute the method described in any of the above-mentioned first aspect.

At a fourth aspect of embodiments of the present application, there is provided a readable storage medium, including a program or an instruction. When the program or the instruction runs on a computer, the method described in any of the above-mentioned first aspect is executed.

In embodiments of the present application, there is provided a method, an apparatus, and a device for determining parameters of a fisheye lens. The fisheye lens includes a meta-lens, the meta-lens includes a first surface and a second surface, and the first surface and the second surface are each provided with a plurality of columnar structures. By means of obtaining a focal length and a projection mode of a fisheye lens to be designed, a light angle offset of each columnar structure is determined based on the focal length and the projection mode; a phase distribution of each columnar structure is determined based on the light angle offset of the columnar structure; and a size of each columnar structure is determined based on the phase distribution of the columnar structure. The fisheye lens conforming to the expected focal length and the projection mode is designed according to the determined size of each columnar structure, which reduces the size of the fisheye lens, and thus a relatively large field angle in a short distance may be achieved.

### BRIEF DESCRIPTION OF THE DRAWINGS

FIG. 1 is a schematic structural diagram of a fisheye lens provided in an embodiment of the present application;

FIG. 2 shows a method for determining parameters of a fisheye lens provided in an embodiment of the present application;

FIG. 3 shows another method for determining parameters of a fisheye lens provided in an embodiment of the present application;

FIG. 4 is a schematic diagram of a fisheye lens provided in an embodiment of the present application;

FIG. 5 is a schematic diagram of a process for G-S optimization iterative algorithm provided in an embodiment of the present application;

FIG. 6 is a schematic diagram of determining a size of a first columnar structure provided in an embodiment of the present application;

FIG. 7 is a schematic diagram of simulation results from a method for determining parameters of a fisheye lens provided in an embodiment of the present application; and

FIG. 8 shows an apparatus for determining parameters of a fisheye lens provided in an embodiment of the present application.

### DETAILED DESCRIPTION

To make the objectives, technical solutions, and advantages of embodiments of the present application clearer, the technical solutions in embodiments of the present application will be described clearly and comprehensively below with reference to the accompanying drawings in embodiments of the present application. Apparently, the described embodiments are merely a part rather than all embodiments of the present application. All other embodiments obtained by persons of ordinary skill in the art based on embodiments of the present application without any creative effort shall fall within the protection scope of the present disclosure.

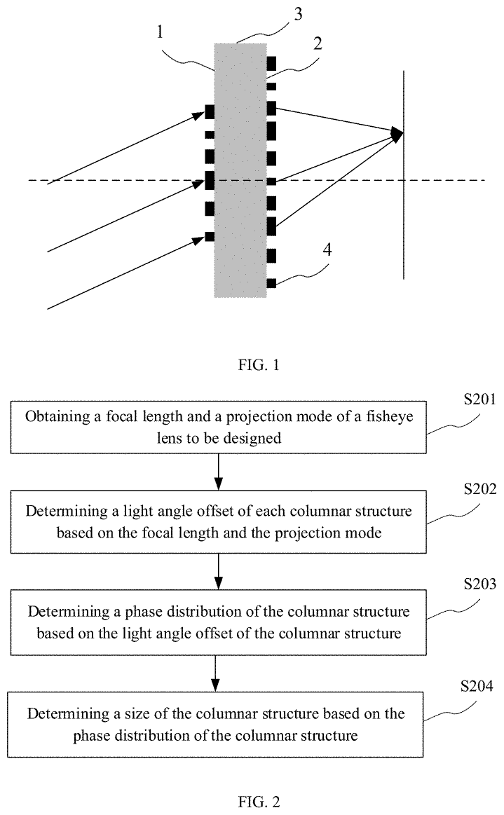

FIG. 1 is a schematic structural diagram of a fisheye lens provided in an embodiment of the present application. Referring to FIG. 1, the fisheye lens includes a first surface 1, a second surface 2 and a fisheye lens body 3, where, the fisheye lens body 3 may be made of silicon dioxide. A plurality of columnar structures 4 are distributed on the first surface 1 and the second surface 2, and the columnar structures may be of polycrystalline silicon. The sizes of different columnar structures 4 may be different. When the sizes of the columnar structures are different, the columnar structures change a phase of light differently. In the process of practical application, the sizes of the columnar structures on the first surface and the second surface may be designed so as to make different columnar structures change the phase of light differently when the light irradiates on the columnar structures of the fisheye lens and then make the scattered light be re-converged, which makes the fisheye lens have a good focusing effect and can achieve relatively large viewing angle at the same time.

The above-mentioned fisheye lens includes the fisheye lens body and the columnar structures on the fisheye lens body, where, both the fisheye lens body and the columnar structures have relatively small sizes, thereby making the fisheye lens have a relatively small size.

The technical solutions shown in the present application will be illustrated in detail in the following through specific embodiments. It should be noted that the following several specific embodiments may be combined with each other. For the same or similar contents, the explanation will not be repeated in different embodiments.

FIG.2 shows a method for determining parameters of a fisheye lens provided by an embodiment of the present application. Referring to FIG.2, the method may include the following.

At S201, a focal length and a projection mode of a fisheye lens to be designed are obtained.

In the embodiment of the present application, an executive body may be not only an electronic device but also an apparatus for determining parameters of a fisheye lens disposed in the electronic device. Optionally, the electronic device may be a computer, a server, a mobile phone, etc. Optionally, the apparatus for determining parameters of a fisheye lens may be achieved not only by a software but also by the combination of a software and a hardware. For ease of description, the executive body being an electronic device will be taken as an example to illustrate in the following.

The electronic device will obtain a focus length and a projection mode of the fisheye lens to be designed when a fisheye lens needs to be designed. The focal length of the fisheye lens is a measurement for measuring light converging in an optical system, and refers to a distance from an optical center of the fisheye lens to a focal point for light converging when parallel light is incoming. The projection mode of the fisheye lens refers to the relationship between an incident angle of parallel light and a position of the focal point, which may reflect both the range of the viewing angle of the light projected through the fisheye lens and the distortion degree of the light.

In the process of practical application, when users need to design a fisheye lens with a larger viewing angle, they may input the parameters of a fisheye lens needed to be designed into an electronic device: the focal length and the projection mode.

Optionally, users may input the parameters of the fisheye lens not only by setting options for the above-mentioned parameters, but also by inputting corresponding parameter values at set positions corresponding to different parameters, which is not specifically limited by embodiments of the present application.

At S202, a light angle offset of each columnar structure is determined according to the focal length and the projection mode.

A light angle offset refers to an offset of angle of light after passing through a fisheye lens, and the light angle offset may be represented by a difference value of wave vectors.

Optionally, the light angle offset of each columnar structure may be determined according to the focal length and the projection mode by the following practicable implementations: determining wave vectors corresponding to each columnar structure based on the focal length, the projection mode and a position of each columnar structure on a meta-lens; determining the light angle offset of the columnar structure based on the wave vectors corresponded by the columnar structure.

Optionally, the projection mode may include but not be limited to: stereographic projection r=2 f tan(θ/2), equidistant projection r=f θ, equiangular projection r=2 f sin(θ/2), and orthogonal projection r=f sin θ, where, r is the perpendicular distance from the focal point to the center of a fisheye lens, f is the focal length of a fisheye lens, and θ is the incident angle of light. As for different projection modes, the method for determining the parameters of a fisheye lens is the same.

Optionally, the fisheye lens may include at least two surfaces. For example, the fisheye lens may include two surfaces, three surfaces, four surfaces, etc. The fisheye lens including two surfaces will be illustrated as an example in the following. The fisheye lens may include a first surface and a second surface; a plurality of columnar structures are distributed on both the first surface and the second surface, positions of respective columnar structure being different; a phase of light penetrating through different columnar structures may be changed differently by the columnar structures at different positions. There may be many kinds of methods for identifying the position of each columnar structure. For example, a distance between the columnar structure and a light axis of the fisheye lens may be identified as the position of the columnar structure. The light axis of the fisheye lens is a reference line, which passes through the central position of the fisheye lens and is perpendicular to the fisheye lens.

The wave vector is a vector whose value represents a wave number k=|k|=2π/λ, where, λ is the wavelength of light, and its direction represents the direction of light propagating. Optionally, the wave vectors corresponding to each columnar structure may include: a first wave vector, a second wave vector, a third wave vector, and a fourth wave vector; where, the first wave vector is a wave vector of the light prior to passing through the first surface from each columnar structure; the second wave vector is a wave vector of the light after passing through the first surface from each columnar structure; the third wave vector is a wave vector of the light prior to passing through the second surface from each columnar structure; and the fourth wave vector is a wave vector of the light after passing through the second surface from each columnar structure.

At S203, a phase distribution of each columnar structure is determined based on the light angle offset of the columnar structure.

The phase distribution of each columnar structure may be used to ensure that an optical path difference of the light passing through the columnar structure is uniform, so that the scattered light may be converged to the focal point with a fixed focal length.

Optionally, the phase distribution of each columnar structure may be determined based on the light angle offset of the columnar structure by means of the following practicable implementations:

determining a first phase variation of each columnar structure on the first surface based on the light angle offset of the columnar structure on the first surface; determining a second phase variation of the columnar structure on the second surface based on the light angle offset of the columnar structure on the second surface; and determining the phase distribution based on the first phase variation and the second phase variation.

Optionally, the light angle offset of the first surface is used to represent the first phase variation per unit length, i.e., the first phase variation may be determined by the light angle offset of the first surface and the position of each columnar structure. Correspondingly, the second phase variation may be determined by the light angle offset of the second surface and the position of each columnar structure.

Optionally, the phase distribution may be determined based on the first phase variation and the second phase variation by the following practicable implementations: integrating the first phase variation of each columnar structure to obtain the phase distribution of the columnar structure on the first surface; and integrating the second phase variation of each columnar structure to obtain the phase distribution of the columnar structure on the second surface.

At S204, a size of each columnar structure is determined based on the phase distribution of the columnar structure.

The size of each columnar structure may include a radius of the columnar structure, which has a corresponding relationship with the phase value of the light passing through the columnar structure.

Optionally, the size of each columnar structure may be determined based on the phase distribution of the columnar structure by the following practicable implementations: determining the phase value of each columnar structure based on the phase distribution of the columnar structure; and determining the size of the columnar structure based on the phase value of the columnar structure and a preset corresponding relationship, where, the preset corresponding relationship includes a plurality of phase values and the size corresponding to each phase value.

Optionally, the phase value of each columnar structure may be determined based on the phase distribution of the columnar structure by the following ways: the phase distribution of each columnar structure is taken as an initial condition, directions x and y being set as periodic boundary conditions, and a direction z being set as an absorbing boundary condition; the phase distribution is such a function that the phase value of each columnar structure may be determined by introducing relevant parameters of the columnar structure into the function; and the phase value of the columnar structure ranges from 0 to 2 π.

In the process of practical application, the size of each columnar structure, such as the radius of each columnar structure, is determined according to the phase value of the columnar structure and the preset corresponding relationship. All of the structural units with determined sizes are arranged on the first surface and the second surface of the fisheye lens, so as to construct a fisheye lens that meets the expected parameters. The phase value of the light passing through the fisheye lens has a corresponding relationship with the radius of each columnar structure.

In embodiments of the present application, there is provided a method, an apparatus, and a device for determining the parameters of a fisheye lens. The fisheye lens includes a meta-lens, the meta-lens including a first surface and a second surface; and a plurality of columnar structures are arranged on the first surface and the second surface. By means of acquiring a focal length and a projection mode of the fisheye lens to be designed, a light angle offset of each columnar structure is determined based on the focal length and the projection mode; a phase distribution of the columnar structure is determined based on the light angle offset of the columnar structure; and a size of the columnar structure is determined based on the phase distribution of the columnar structure. The fisheye lens conforming to the expected focal length and the projection mode is designed according to the determined size of each columnar structure, which reduces the size of the fisheye lens, and thus a relatively large field angle in a short distance may be achieved.

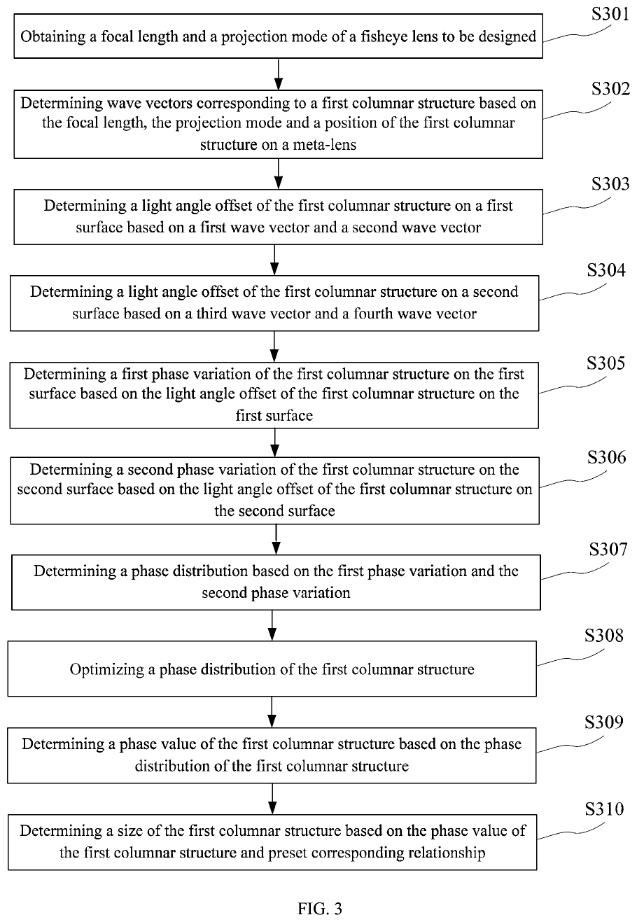

On the basis of the above-mentioned embodiments, the process for determining the size of each columnar structure in a plurality of columnar structures is the same. The process for determining the size of a first columnar structure will be illustrated as an example in the following with reference to FIG. 3.

FIG. 3 shows another method for determining parameters of the fisheye lens provided by embodiments of the present application. Referring to FIG. 3, the method may include the following.

At S301, a focal length and a projection mode of a fisheye lens to be designed are obtained.

For ease of description, embodiments of the present application will be illustrated by taking the projection mode being r=a f sin(θ/a) as an example.

It should be noted that execution process of S301 may refer to that of S201, which will not be repeated here.

At S302, wave vectors corresponding to a first columnar structure are determined based on the focal length, the projection mode and the position of the first columnar structure on the meta-lens.

The wave vectors corresponding to the first columnar structure include a first wave vector, a second wave vector, a third wave vector and a fourth wave vector.

The first wave vector is the wave vector of the light prior to passing through the first surface from the first columnar structure.

The second wave vector is the wave vector of the light after passing through the first surface from the first columnar structure.

The third wave vector is the wave vector of the light prior to passing through the second surface from the first columnar structure.

The fourth wave vector is the wave vector of the light after passing through the second surface from the first columnar structure.

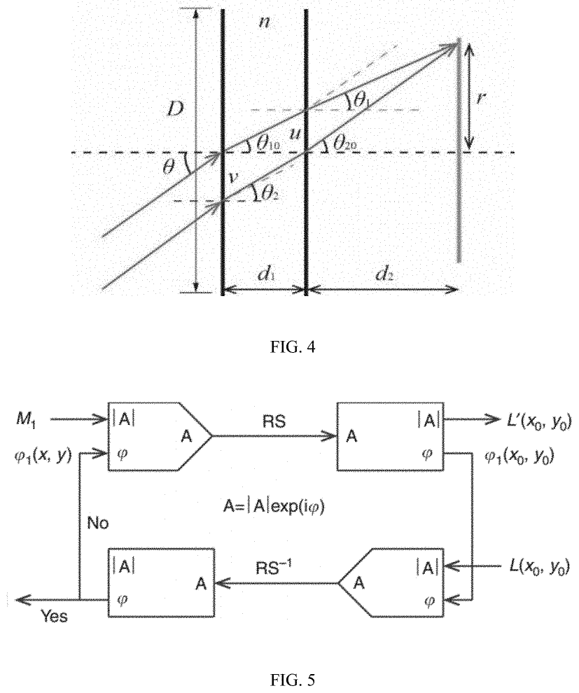

Optionally, the wave vectors corresponding to the first columnar structure may be determined according to the focal length, the projection mode and the position of the first columnar structure on the meta-lens by the following practicable implementations. Determining the wave vectors corresponding to the first columnar structure of the fish eye lens, shown in embodiments of the present application, will be illustrated by specific examples in the following with reference to FIG. 4.

FIG. 4 is a schematic diagram of the fisheye lens provided in the embodiments of the present application. Referring to FIG. 4, n is a refractive index of the fisheye lens; d₁ is a thickness of the fisheye lens; and d₂ is a focal length of the fisheye lens. Specifically, d₂ is a distance from the second surface of the fisheye lens to an imaging surface; θ is an incident angle of a first parallel light and a second parallel light; θ₁₀ is an exit angle of the first parallel light passing through the first surface; θ₂ is an exit angle of the second parallel light passing through the first surface; θ₁ is an exit angle of the first parallel light passing through the second surface; θ₂₀ is an exit angle of the second parallel light passing through the second surface; v represents a position of the first columnar structure on the first surface of the fisheye lens (i.e., the position of the light passing through the columnar structure of the first surface); u represents a position of the first columnar structure on the second surface of the fisheye lens (i.e., the position of the light passing through the columnar structure of the second surface); and r represents a perpendicular distance from the focal point to the center of the lens. The light includes the first parallel light and the second parallel light; the first parallel light is a reference light passing through a center point of the first surface; the center point of the first surface is an intersection point of the first surface and an optical axis of the fisheye lens; the optical axis is the reference line perpendicular to the fisheye lens and passing through the center of the fisheye lens, having a coordinate of 0; the second parallel light is the light passing through the fisheye lens from the first columnar structure; and the first parallel light is parallel to the second parallel light.

It should be noted that, in embodiments of the present application, the following specific parameter values are taken as examples to illustrate. Of course, the specific parameters may also be set as other values according to actual requirements: n=1.5, d₁=200 μm, d₂=400 μm, and the wavelengths of the first parallel light and the second parallel light λ are both 635 nm.

Optionally, in embodiments of the present application, the following may be obtained according to Snell's Law:

si n θ=n si n θ₁₀,

n si n θ₂=si n θ₂₀;

the first wave vector is represented as:

kᵥ₁=k₀ si n θ;

or, the second wave vector is represented as:

kᵥ₂=nk₀ si n θ₂;

or, the third wave vector is represented as:

kᵤ₁=nk₀ si n θ₁₀;

or, the fourth wave vector is represented as:

kᵤ₂=k₀ si n θ₁;

where, k₀ is the wave vector in vacuum, k₀=2π l λ; n is the refractive index of the meta-lens, θ is the incident angle of the first parallel light and the second parallel light, θ₁₀ is the exit angle of the first parallel light passing through the first surface, θ₂ is the exit angle of the second parallel light passing through the first surface, and θ₁ is the exit angle of the first parallel light passing through the second surface; and θ₂₀ is an exit angle of the second parallel light passing through the second surface.

At S303, a light angle offset of the first columnar structure on the first surface is determined based on the first wave vector and the second wave vector.

Optionally, based on the first wave vector and the second wave vector, the light angle offset of the first columnar structure on the first surface is determined as:

Δkᵥ=kᵥ₁−kᵥ₂.

At S304, a light angle offset of the first columnar structure on the second surface is determined based on the third wave vector and the fourth wave vector.

Optionally, based on the third wave vector and the fourth wave vector, the light angle offset of the first columnar structure on the second surface is determined as:

Δkᵤ=kᵤ₁−kᵤ₂.

At S305, a first phase variation of the first columnar structure on the first surface is determined based on the light angle offset of the first columnar structure on the first surface.

Optionally, according to the light angle offset of the first columnar structure on the first surface, it may be obtained that:

the first phase variation of the first columnar structure is represented as:

Δϕ₁(v)=dv·Δkᵥ.

At S306, a second phase variation of the first columnar structure on the second surface is determined based on the light angle offset of the first columnar structure on the second surface.

Based on the light angle offset of the first columnar structure on the second surface, it may be obtained that:

the second phase variation of the first columnar structure is represented as:

Δϕ₁(u)=du·Δkᵤ.

At S307, a phase distribution is determined based on the first phase variation and the second phase variation.

Optionally, the phase distribution may be determined according to both the first phase variation and the second phase variation of the first columnar structure by the following practicable implementations: integrating the first phase variation and the second phase variation respectively to obtain phase distributions of the first columnar structure on the first surface and the second surface.

At S308, the phase distributions of the first columnar structure are optimized.

Optionally, the phase distributions of the first columnar structure may be optimized after the phase distributions of the first columnar structure are obtained.

Optionally, the phase distributions of the first columnar structure may be optimized by the following practicable implementations: taking the phase distributions of the first columnar structure on the first surface and the second surface as the initial condition, and using a diffraction-based iterative optimization algorithm to optimize the phase distributions of the first columnar structure on the first surface and the second surface. Specifically, in embodiments of the present application, traditional G-S optimization iterative algorithm and Rayleigh-Sommerfeld diffraction formula are used to optimize the phase distribution.

In the process of practical application, the specific optimization process using the Rayleigh-Sommerfeld diffraction formula and the traditional G-S optimization iterative algorithm to optimize the phase distribution is described as follows:

an electric field distribution of any one plane in space may be represented as E (x, y)=A(x, y) e^{iφ(x, y)};

given the electric field distribution of the first surface in space, the distribution of electric field propagating to the second surface may be calculated by the Rayleigh-Sommerfeld diffraction formula, and specifically, the Rayleigh-Sommerfeld diffraction formula is represented as follows:

$$U ( {x}_{0} , {y}_{0} ) = \frac{1}{i λ} \int \int U ( x , y ) cos < n , r > \frac{exp ( ikr )}{r} dxdy ,$$

where, r=\sqrt{(x₀−x)²+(y₀−y)²}, cos<n, r>=z/r,

each of (x₀, y₀) and (x, y) is any point on the first surface and the second surface, and z is a distance between the first surface and the second surface.

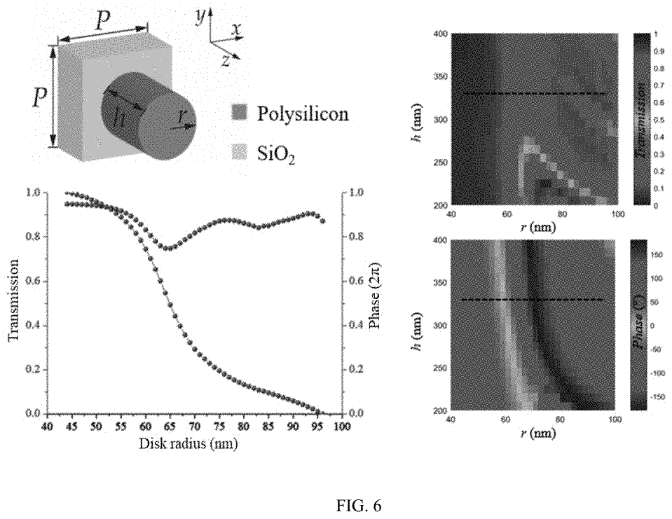

The G-S optimization iterative algorithm process will be illustrated in detail in the following with reference to FIG. 5.

FIG.5 is a schematic process diagram of G-S optimization iterative algorithm provided by embodiments of the present application. Referring to FIG. 5, after the electric field distributions of the first surface and the second surface are determined, the phase distribution phases and a constant amplitude distribution phase (A (x, y)=1) in the initial conditions are combined as an initial electric field, and the electric field distribution on a focal plane may be calculated by using the Rayleigh-Sommerfeld diffraction formula. The phase distribution of the electric field distribution is retained, an amplitude part is replaced with a desired result (i.e., an amplitude distribution of the focused focal spot). Then, the new electric field distribution is propagated reversely, and processed with the Rayleigh-Sommerfeld diffraction formula again to obtain the electric field distribution at an initial input plane. The obtained phase distribution of the electric field distribution is retained, and the amplitude distribution is replaced with the constant amplitude distribution so as to form a new input. The above-mentioned process constitutes a cycle, as shown in FIG. 5. After many iterations, L′(x, y) is more and more close to the expected result L (x, y). Finally, the phase distribution of the first columnar structure is optimized.

At S309, a phase value of the first columnar structure is determined based on the phase distribution of the first columnar structure.

Optionally, the phase value of the first columnar structure may be determined based on the phase distribution of the first columnar structure by the following ways: taking the phase distribution of the first columnar structure as the initial condition, where setting the directions x and y are set as the periodic boundary conditions, the direction z is set as the absorbent boundary condition, and the phase distribution is a function; and introducing the relevant parameters of the first columnar structure into the function to determine the phase value of the first columnar structure, where, the phase value of the first columnar structure ranges from 0 to 2π.

At S310, a size of the first columnar structure is determined based on the phase value of the first columnar structure and the preset corresponding relationship.

The preset corresponding relationship includes a plurality of phase values and a size corresponding to each phase value.

Optionally, the size of the first columnar structure may include the radius of the first columnar structure.

With reference to FIG. 6, determining the size of the first columnar structure based on the phase distribution of the first columnar structure provided in embodiments of the present application will be illustrated in the following.

FIG. 6 is a schematic diagram of determining the size of the first columnar structure provided in embodiments of the present application. Referring to FIG. 6, the phase variation range 2π required by the first surface and the second surface of the fisheye lens may be obtained only by changing the radius of the first columnar structure. At the same time, the transmissivity of the fisheye lens is always maintained at a very high state. In the process of practical application, a first structural unit with determined size is arranged at the positions corresponding to the size on the first surface and the second surface of the fisheye lens, so as to construct the fisheye lens that meets the expected parameters.

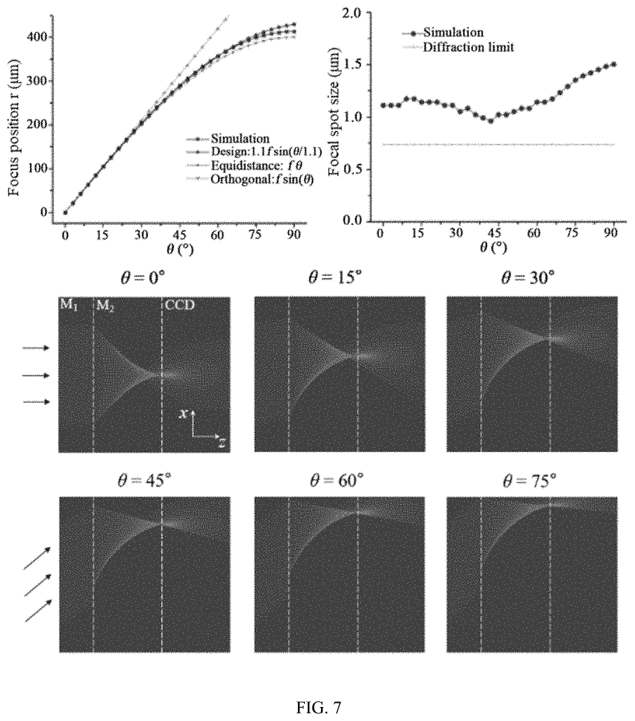

The performance of the fisheye lens provided in embodiments of the present application will be illustrated in detail with reference to FIG. 7 in the following.

FIG. 7 is a schematic diagram of the simulation results of a method for determining the parameters of fisheye lens provided in embodiments of the present application. Referring to FIG. 7, a good focusing effect may always be obtained when the incident angle changes from 0° to nearly 90°. The projection relationship shown in the simulation results is identical well with the design, where the deviation will keep slightly obvious when the incident angle is greater than 75°, which may be solved by increasing the size of the super surface. Under any incident angle, the focal spot size perceived by the imaging surface (illustrated by CCD20 in the figure) is little different from the diffraction limit, and the energy of most incident light is focused at a certain point on the imaging surface (illustrated by CCD in the figure), which also indicates that the better focusing effect of the fisheye lens, thereby achieving a larger viewing field in short distance.

Embodiments of the present application provide a method, an apparatus, and a device for determining parameters of a fisheye lens. The fisheye lens includes a meta-lens, the meta-lens includes a first surface and a second surface, and a plurality of columnar structures are arranged on the first surface and the second surface. Taking the process of determining the size of the first columnar structure as an example, by obtaining the focal length and the projection mode of the fisheye lens to be designed, the light angle offset of each columnar structure is determined based on the focal length and the projection mode. The phase distribution of each columnar structure is determined based on the light angle offset of the columnar structure and optimized, and the size of each columnar structure is determined based on the optimized phase distribution of the each columnar structure. Then, the fisheye lens conforming to the expected focal length and the projection mode may be designed according to the determined size of each columnar structure, which reduces the size of the fisheye lens and may achieve a larger viewing field in a short distance.

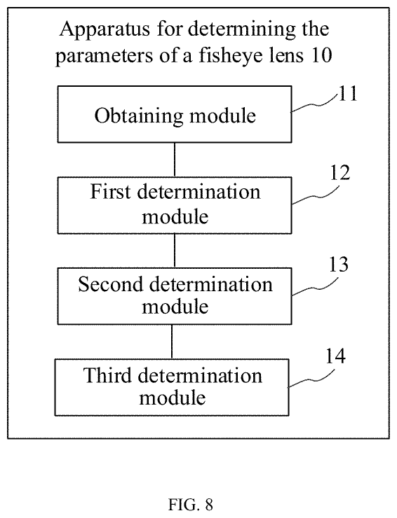

FIG. 8 is an apparatus for determining parameters of a fisheye lens provided in embodiments of the present application. Referring to FIG. 8, the apparatus 10 for determining the parameters of fisheye lens may include:

an obtaining module 11 configured to obtain a focal length and a projection mode of a fisheye lens to be designed;

a first determination module 12 configured to determine a light angle offset of each columnar structure based on the focal length and the projection mode;

a second determination module 13 configured to determine a phase distribution of the columnar structure based on the light angle offset of the columnar structure; and

a third determination module 14 configured to determine a size of the columnar structure based on the phase distribution of the columnar structure.

The apparatus for determining the parameters of a fisheye lens provided in embodiments of the present application may perform the technical solutions shown in the above-mentioned method embodiments, the principles and beneficial effects of those are similar, so it will not be repeated here.

In another possible embodiment, the first determination module 12 is specifically configured to:

determine wave vectors corresponding to each columnar structure based on the focal length, the projection mode and the position of the columnar structure on the meta-lens; and

determine the light angle offset of the columnar structure based on the wave vectors corresponding to the columnar structure.

In another possible embodiment, for the first columnar structure in the plurality of columnar structures, the wave vectors corresponding to the first columnar structure include: a first wave vector, a second wave vector, a third wave vector and a fourth wave vector;

where,

the first wave vector is the wave vector of the light prior to passing through the first surface from the first columnar structure;

the second wave vector is the wave vector of the light after passing through the first surface from the first columnar structure;

the third wave vector is the wave vector of the light prior to passing through the second surface from the first columnar structure;

the fourth wave vector is the wave vector of the light after passing through the second surface from the first columnar structure.

In another possible embodiment, the first wave vector is represented as:

kᵥ₁=k₀ si n θ;

or, the second wave vector is represented as:

kᵥ₂=nk₀ si n θ₂;

or, the third wave vector is represented as:

kᵤ₁=nk₀ si n θ₁₀;

or, the fourth wave vector is represented as:

kᵤ₂=k₀ si n θ₁,

where, k₀ is the wave vector in vacuum and k₀=2π l λ; n is the refractive index of the meta-lens; θ is the incident angle of the first parallel light and the second parallel light; θ₁₀ is the exit angle of the first parallel light passing through the first surface from the first columnar structure, θ₂ is the exit angle of the second parallel light passing through the first surface from the first columnar structure, and θ₁ is the exit angle of the first parallel light passing through the second surface.

In another possible embodiment, for the first columnar structure in the plurality of columnar structures, the first determination module 12 is specifically configured to:

determine the light angle offset of the first columnar structure on the first surface based on the first wave vector and the second wave vector; and

determine the light angle offset of the first columnar structure on the second surface based on the third wave vector and the fourth wave vector.

In another possible embodiment, for the first columnar structure in the plurality of columnar structures, the second determination module 13 is specifically configured to:

determine a first phase variation of the first columnar structure on the first surface based on the light angle offset of the first columnar structure on the first surface;

determine a second phase variation of the first columnar structure on the second surface based on the light angle offset of the first columnar structure on the second surface; and

determine the phase distribution based on the first phase variation and the second phase variation.

In another possible embodiment, the third determination module 14 is specifically configured to:

determine a phase value of each columnar structure based on a phase distribution of the columnar structure; and

determine a size of the columnar structure based on the phase value of the columnar structure and a preset corresponding relationship, where the preset corresponding relationship includes a plurality of phase values and the size corresponding to each phase value.

The apparatus for determining the parameters of a fisheye lens provided in embodiments of the present application may perform the technical solutions shown in the above-mentioned method embodiments, the principles and beneficial effects of which are similar and will not be repeated here.

In an embodiment of the present application, there is provided a terminal device, including: a processor coupled with a memory;

the memory is configured to store a computer program;

the processor is configured to execute the computer program stored in the memory to enable the terminal device to execute the method described in any of the above-mentioned method embodiments.

In an embodiment of the present application, there is provided a readable storage medium, including a program or an instruction. When the program or the instruction runs on a computer, the method as described in any of the above-mentioned method embodiments is executed.

The ordinary persons skilled in the art may understand that: all or part of the steps to realize the above-mentioned method embodiments may be completed by hardware related to the program or instruction. The aforementioned program may be stored in a computer-readable storage medium. When the program is executed, the steps including the above-mentioned method embodiments are executed. The above storage medium includes various media that may store program codes, such as ROM (read only memory), RAM (random access memory), magnetic disc or optical disc, etc.

Finally, it should be noted that: the above-mentioned embodiments are only intended for illustrating the technical solutions of embodiments of the present application other than limiting the present application. Although embodiments of the present application have been described in detail with reference to the foregoing embodiments, those skilled in the art should understand that they may still make modifications to the technical solutions described in the foregoing embodiments, or make equivalent substitutions to some or all of the technical features thereof; and these modifications or substitutions do not make the essence of the corresponding technical solutions depart from the scope of embodiments of the present application.

What is claimed is:

1. A method for determining parameters of a fisheye lens, wherein the fisheye lens comprises a meta-lens, the meta-lens comprises a first surface and a second surface, and the first surface and the second surface are each provided with a plurality of columnar structures, the method comprises:
obtaining a focal length and a projection mode of a fisheye lens to be designed;
determining a light angle offset of each columnar structure based on the focal length and the projection mode;
determining a phase distribution of the each columnar structure based on the light angle offset of the each columnar structure respectively; and
determining a size of the each columnar structure based on the phase distribution of the each columnar structure.

2. The method according to claim 1, wherein determining the light angle offset of the each columnar structure based on the focal length and the projection mode comprises:
determining wave vectors corresponding to the each columnar structure based on the focal length, the projection mode and a position of the each columnar structure on the meta-lens; and
determining the light angle offset of the each columnar structure based on the wave vectors corresponding to the each columnar structure.

3. The method according to claim 2, wherein for a first columnar structure in the plurality of columnar structures, the wave vectors corresponding to the first columnar structure comprise: a first wave vector, a second wave vector, a third wave vector and a fourth wave vector; wherein
the first wave vector is a wave vector of the light prior to passing through the first surface from the first columnar structure;
the second wave vector is a wave vector of the light after passing through the first surface from the first columnar structure;
the third wave vector is a wave vector of the light prior to passing through the second surface from the first columnar structure; and
the fourth wave vector is a wave vector of the light after passing through the second surface from the first columnar structure.

4. The method according to claim 3, wherein
the first wave vector is represented as:
kᵥ₁=k₀ si n θ;
or, the second wave vector is represented as:
kᵥ₂=nk₀ si n θ₂;
or, the third wave vector is represented as:
kᵤ₁=nk₀ si n θ₁₀;
or, the fourth wave vector is represented as:
kᵤ₂=k₀ si n θ₁;
wherein k₀ is a wave vector in vacuum, k₀=2λ l λ, n is a refractive index of the meta-lens, θ is an incident angle of the first parallel light and the second parallel light, θ₁₀ is an exit angle of the first parallel light passing through the first surface from the first columnar structure, θ₂ is an exit angle of the second parallel light passing through the first surface from the first columnar structure, and θ₁ is an exit angle of the first parallel light passing through the second surface.

5. The method according to claim 3, wherein for the first columnar structure in the plurality of columnar structures, determining a light angle offset of the first columnar structure based on the wave vectors corresponding to the first columnar structure comprises:
determining a light angle offset of the first columnar structure on the first surface based on the first wave vector and the second wave vector; and
determining a light angle offset of the first columnar structure on the second surface based on the third wave vector and the fourth wave vector.

6. The method according to claim 5, wherein for the first columnar structure in the plurality of columnar structures, determining a phase distribution of the first columnar structure based on the light angle offset of the first columnar structure comprises:
determining a first phase variation of the first columnar structure on the first surface based on the light angle offset of the first columnar structure on the first surface;
determining a second phase variation of the first columnar structure on the second surface based on the light angle offset of the first columnar structure on the second surface; and
determining the phase distribution based on the first phase variation and the second phase variation.

7. The method according to claim 4, wherein for the first columnar structure in the plurality of columnar structures, determining a light angle offset of the first columnar structure based on the wave vectors corresponding to the first columnar structure comprises:
determining a light angle offset of the first columnar structure on the first surface based on the first wave vector and the second wave vector; and
determining a light angle offset of the first columnar structure on the second surface based on the third wave vector and the fourth wave vector.

8. The method according to claim 7, wherein for the first columnar structure in the plurality of columnar structures, determining a phase distribution of the first columnar structure based on the light angle offset of the first columnar structure comprises:
determining a first phase variation of the first columnar structure on the first surface based on the light angle offset of the first columnar structure on the first surface;
determining a second phase variation of the first columnar structure on the second surface based on the light angle offset of the first columnar structure on the second surface; and
determining the phase distribution based on the first phase variation and the second phase variation.

9. The method according to claim 1, wherein determining the size of the each columnar structure based on the phase distribution of the each columnar structure comprises:
determining a phase value of the each columnar structure based on the phase distribution of the each columnar structure; and
determining the size of the each columnar structure based on the phase value of the each columnar structure and preset corresponding relationship, wherein the preset corresponding relationship comprises a plurality of phase values and a size corresponding to each phase value.

10. The method according to claim 2, wherein determining the size of the each columnar structure based on the phase distribution of the each columnar structure comprises:
determining a phase value of the each columnar structure based on the phase distribution of the each columnar structure; and
determining the size of the each columnar structure based on the phase value of the each columnar structure and preset corresponding relationship, wherein the preset corresponding relationship comprises a plurality of phase values and a size corresponding to each phase value.

11. The method according to claim 3, wherein determining the size of the each columnar structure based on the phase distribution of the each columnar structure comprises:
determining a phase value of the each columnar structure based on the phase distribution of the each columnar structure; and
determining the size of the each columnar structure based on the phase value of the each columnar structure and preset corresponding relationship, wherein the preset corresponding relationship comprises a plurality of phase values and a size corresponding to each phase value.

12. The method according to claim 4, wherein determining the size of the each columnar structure based on the phase distribution of the each columnar structure comprises:
determining a phase value of the each columnar structure based on the phase distribution of the each columnar structure; and
determining the size of the each columnar structure based on the phase value of the each columnar structure and preset corresponding relationship, wherein the preset corresponding relationship comprises a plurality of phase values and a size corresponding to each phase value.

13. An apparatus for determining parameters of a fisheye lens, wherein the fisheye lens comprises a meta-lens, the meta-lens comprises a first surface and a second surface, and the first surface and the second surface are each provided with a plurality of columnar structures, the apparatus comprising:
an obtaining module configured to obtain a focal length and a projection mode of a fisheye lens to be designed;
a first determination module configured to determine a light angle offset of each columnar structure based on the focal length and the projection mode;
a second determination module configured to determine a phase distribution of the each columnar structure based on the light angle offset of the each columnar structure;
a third determination module configured to determine a size of the each columnar structure based on the phase distribution of the each columnar structure respectively.

14. An apparatus for determining parameters of a fisheye lens, wherein comprising:
at least a processor and a memory;
the memory is configured to store a computer program instruction;
the at least one processor is configured to execute the computer program instruction stored in the memory so as to allow the at least one processor to execute the method for determining the parameters of the fisheye lens according to claim 1.

15. The apparatus according to claim 14, wherein the determining the light angle offset of the each columnar structure based on the focal length and the projection mode comprises:
determining wave vectors corresponding to the each columnar structure based on the focal length, the projection mode and a position of the each columnar structure on the meta-lens; and
determining the light angle offset of the each columnar structure based on the wave vectors corresponding to the each columnar structure.

16. The apparatus according to claim 15, wherein for a first columnar structure in the plurality of columnar structures, the wave vectors corresponding to the first columnar structure comprise: a first wave vector, a second wave vector, a third wave vector and a fourth wave vector; wherein
the first wave vector is a wave vector of the light prior to passing through the first surface from the first columnar structure;
the second wave vector is a wave vector of the light after passing through the first surface from the first columnar structure;
the third wave vector is a wave vector of the light prior to passing through the second surface from the first columnar structure; and
the fourth wave vector is a wave vector of the light after passing through the second surface from the first columnar structure.

17. The apparatus according to claim 16, wherein
the first wave vector is represented as:
kᵥ₁=k₀ si n θ;
or, the second wave vector is represented as:
kᵥ₂=nk₀ si n θ₂;
or, the third wave vector is represented as:
kᵤ₁=nk₀ si n θ₁₀;
or, the fourth wave vector is represented as:
kᵤ₂=k₀ si n θ₁;
wherein k₀ is a wave vector in vacuum, k₀=2π l λ, n is a refractive index of the meta-lens, θ is an incident angle of the first parallel light and the second parallel light, θ₁₀ is an exit angle of the first parallel light passing through the first surface from the first columnar structure, θ₂ is an exit angle of the second parallel light passing through the first surface from the first columnar structure, and θ₁ is an exit angle of the first parallel light passing through the second surface.

18. A non-transitory computer-readable storage medium, wherein a computer program instruction is stored in the computer-readable storage medium, and the method for determining the parameters of the fisheye lens according to claim 1 is realized when a processor executes the computer program instruction.

19. The non-transitory computer-readable storage medium according to claim 18, wherein the determining the light angle offset of the each columnar structure based on the focal length and the projection mode comprises:
determining wave vectors corresponding to the each columnar structure based on the focal length, the projection mode and a position of the each columnar structure on the meta-lens; and
determining the light angle offset of the each columnar structure based on the wave vectors corresponding to the each columnar structure.

20. The non-transitory computer-readable storage medium according to claim 19, wherein for a first columnar structure in the plurality of columnar structures, the wave vectors corresponding to the first columnar structure comprise: a first wave vector, a second wave vector, a third wave vector and a fourth wave vector; wherein
the first wave vector is a wave vector of the light prior to passing through the first surface from the first columnar structure;
the second wave vector is a wave vector of the light after passing through the first surface from the first columnar structure;
the third wave vector is a wave vector of the light prior to passing through the second surface from the first columnar structure; and
the fourth wave vector is a wave vector of the light after passing through the second surface from the first columnar structure.
